(19) United States
(12) Patent Application Publication
(10) Pub. No.: US 2006/0292422 A1
(43) Pub. Date: Dec. 28, 2006

(54) Fuel tank and fuel cell system including the same

(75) Inventor: In Hyuk Son, Yongin (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/376,324

(22) Filed: Mar. 16, 2006

(30) Foreign Application Priority Data
Jun. 24, 2005 (KR) 2005-55293

(51) Int. Cl. H01M 8/04; B65D 90/02

(52) U.S. Cl. 429/34; 220/565

(57) ABSTRACT

A fuel cell fuel tank includes a flexible pipe arranged within the fuel tank housing and coupled with a feeding pipe and a weight coupled with a free end of the flexible guiding pipe, so that a hydrogen containing fuel may be continuously supplied regardless of the orientation of the fuel tank.

### CROSS REFERENCE TO RELATED APPLICATION

This application claims priority to and the benefit of Korean Patent Application No. 10-2005-0055293, filed on Jun. 24, 2005, which is hereby incorporated by reference for all purposes as if fully set forth herein.

### BACKGROUND

1. Field of the Invention

The present invention relates to a fuel tank for storing a hydrogen containing fuel to be supplied to a stack for generating electricity by an electrochemical reaction between hydrogen and an oxidizing agent such as oxygen, and more particularly, to a fuel tank in which a hydrogen containing fuel may be continuously supplied to a stack regardless of the orientation of the fuel tank.

2. Discussion of the Background

In general, a fuel cell system generates electricity by an electrochemical reaction of hydrogen and oxygen. Fuel cell systems have been researched and developed as an alternative power source to meet an increased demand for power and to solve environmental problems. Fuel cell systems may be useful in various applications, such as mobile devices, transportation, distributed power sources, and other applications depending on characteristics of the fuel cell, such as the types of fuel used, the driving temperature, and the output range.

Fuel cell systems may be classified according to the type of electrolyte used, such as a phosphoric acid fuel cell (PAFC), a molten carbon fuel cell (MCFC), a solid oxide fuel cell (SOFC), a polymer electrolyte membrane fuel cell (PEMFC), an alkaline fuel cell (AFC). The foregoing fuel cell systems may be provided with a fuel tank for storing hydrogen containing fuel. The fuel may be supplied to a stack or a reformer of the fuel cell system by a pump, or by pressurized inert gas such as nitrogen, argon, or helium. The fuel flow may be controlled by a mass flow meter or the like.

Conventional fuel tanks have been disclosed in Korean laid-open patent No. 10-2004-0000556, Korean laid-open patent No. 10-2005-0003791, and Japanese laid-open patent No. 2003-109633.

Korean Patent Publication No. 10-2004-0000556 discloses a fuel tank for a fuel cell that uses B compound as a fuel. The fuel tank includes a float placed in a tank body that floats on the surface of the BH₄⁻ solution, and a flexible tube having a lower part coupled to the float and an upper part coupled to a supplying pipe.

Korean patent laid-open No. 2005-3791 discloses a fuel cell feeding controller for a fuel cell vehicle that controls a fuel supplying control assembly.

Japanese patent laid-open No. 2003-109633 discloses a fuel reservoir for a liquid fuel cell that includes a reservoir and a wicking structure placed in the reservoir to supply liquid fuel.

However, there remains a need for a structure to immerse a flexible guiding pipe in a fuel to continuously supply fuel from a fuel tank to a stack or reformer even when the fuel tank is oriented in an inclined or reversed position.

### SUMMARY OF THE INVENTION

This invention provides a fuel tank in which fuel may be continuously supplied to a stack or a reformer even when the fuel cell system is oriented in an inclined or reversed position.

The present invention also provides a fuel cell system, which includes the fuel tank.

Additional features of the invention will be set forth in the description which follows, and in part will be apparent from the description, or may be learned by practice of the invention.

The present invention discloses a fuel cell fuel tank, including a housing to store a hydrogen containing fuel, the housing including an opening at one side; a feeding pipe coupled with the opening; a flexible pipe coupled with the feeding pipe via the opening, the flexible pipe arranged within the housing; and a weight coupled with a free end of the flexible pipe.

The present invention also discloses a fuel cell system, including an electricity generator to generate electricity using an electrochemical reaction between hydrogen and oxygen; and a fuel feeder to supply a hydrogen containing fuel to the electricity generator, wherein the fuel feeder includes a housing to store a hydrogen containing fuel, the housing including an opening at one side; a feeding pipe coupled with the opening; a flexible pipe coupled with the feeding pipe via the opening, the flexible pipe arranged within the housing; and a weight coupled with a free end of the flexible pipe.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic view illustrating a fuel cell system with a fuel tank according to an exemplary embodiment of the present invention.

FIG. 2 is a schematic view illustrating a fuel tank according to an exemplary embodiment of the present invention.

FIG. 3 is a schematic view illustrating a fuel tank with a float according to an exemplary embodiment of the present invention.

FIG. 4 is a schematic view illustrating the fuel tank of FIG. 3 in an inverted state.

FIG. 5 is a schematic view illustrating a fuel tank having a rounded housing structure according to an exemplary embodiment of the present invention.

FIG. 6 is a schematic view illustrating a weight structure installed in the fuel tank of FIG. 5.

FIG. 7 is a schematic view illustrating a weight structure according to an exemplary embodiment of the present invention.

FIG. 8 is a schematic view illustrating a fuel tank including the weight of FIG. 7.

FIG. 9 is a schematic view illustrating a porous weight according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

Hereinafter, a direct methanol fuel cell (DMFC) will be representatively described, in which a hydrogen containing fuel is supplied directly to a stack to generate electricity. The fuel used in a DMFC may be an alcoholic fuel, such as methanol or ethanol, a hydro-carbon fuel, such as methane, propane, or butane, or a natural gas fuel, such as liquefied natural gas. However, the present invention is not limited to a DMFC, and may be applied to other types of fuel cells, such as a polymer electrolyte membrane fuel cell (PEMFC), which includes a reformer to reform the hydrogen containing fuel to obtain hydrogen gas.

As shown in FIG. 1, a DMFC may include a stack 20, a fuel feeder 10, and an air feeder. The stack may include a plurality of stacked unit cells that generate electricity based on an electromechanical reaction between hydrogen and oxygen. The fuel feeder 10 may supply fuel to the stack 20. The air feeder 30 may supply an oxidizing agent such as the oxygen in air to the stack 20.

The stack 20 may include a plurality of unit cells, each of which may include a membrane electrode assembly (MEA) including a polymer membrane, and a cathode and an anode arranged on opposite sides of the polymer membrane. The fuel may be supplied from the fuel feeder 10 to the anode of the stack 20, and oxygen in air may be supplied to the cathode through the air feeder 30. The electricity generated in the stack 20 by the electrochemical reaction between hydrogen and oxygen may flow through a current collector to an external circuit. CO₂ and water may be created as byproducts of the electrochemical reaction. CO2 may be discharged to the atmosphere, and water may be discharged or recycled.

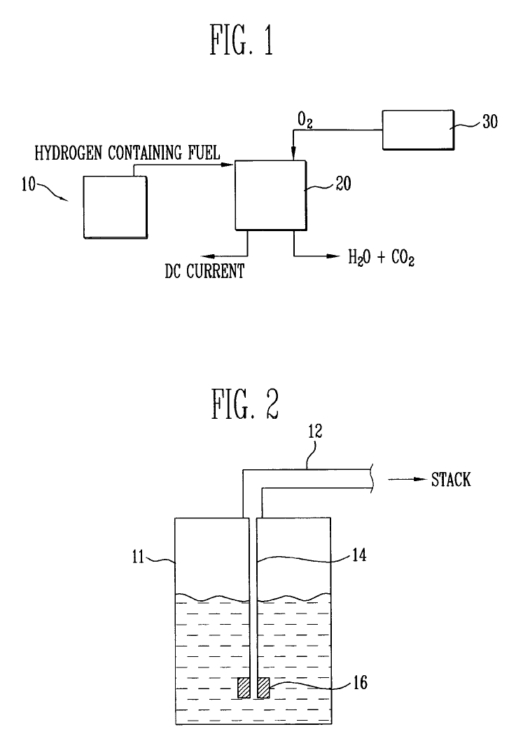

Referring to FIG. 2, the fuel feeder 10 may include a housing 11 to store the fuel. The housing 11 may be formed with an opening at one side, a feeding pipe 12 communicating with the housing 11 through the opening to transport the fuel to the stack 20, and a feeder (not shown) to supply the fuel to the stack 20 through the feeding pipe 12. The feeder may operate using a driving means such as a motor, or a pneumatic device that supplies inert gas, such as nitrogen, argon, or helium to the housing 11.

According to an exemplary embodiment of the present invention, the interior of the fuel feeder 10 may be provided with a flexible guiding pipe 14 coupled with the housing 11 and with the feeding pipe 12 through the opening of the housing 11. Further, the flexible guiding pipe 14 may be provided with a weight 16 at its free end.

Alternatively, referring to FIG. 9, a weight 216 may have a plurality of pores 216a to filter the fuel to be transported to the feeding pipe 12. The weight 216 may be a porous material such as a porous metal, a porous ceramic, or the like. The plurality of pores 216a may filter impurities from the fuel to supply purified fuel to the stack 20.

The weight 16 may be formed with a through hole, and the free end of the flexible guiding pipe 14 may be inserted into the through hole. The weight 16 may cause the free end of the flexible guiding pipe 14 to be placed by gravity in the lowest position of the housing 11. Thus, the fuel stored in the housing 11 may be continuously supplied to the stack 20 by the feeder via the through hole of the weight 16, an inlet hole formed in the free end of the flexible guiding pipe 14, and the feeding pipe 12.

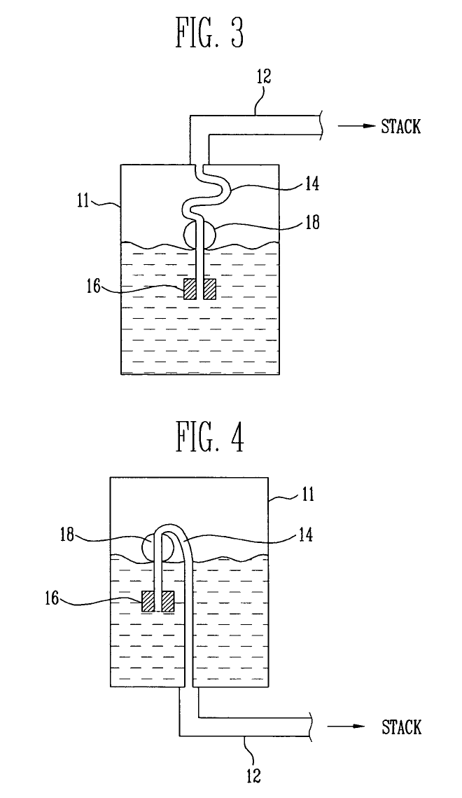

Referring to FIG. 3, the flexible guiding pipe 14 may be provided with a float 18 between the free end of the flexible pipe and a fixed end of the flexible pipe coupled to the opening of the housing 11. The specific gravity of the float 18 may be less than that of the fuel so that the float 18 floats on the fuel while the free end of the flexible guiding pipe 14 is immersed in the fuel by the weight 16. The float 14 and the weight 16 may maintain the free end of the flexible guiding pipe 14 at a distance from an inner wall of the housing 11 so that the fuel may be continuously supplied to the stack 20.

As shown in FIG. 4, if the housing 11 is reversed or flipped upside down, the free end of the flexible guiding pipe 14 may remain immersed in the hydrogen containing fuel by the weight 16. Further, the float 18 may float on the fuel, and may keep the weight 16 positioned at a distance from the inner wall of the housing 11. Therefore, a continuous supply of fuel to the stack 20 may not be interrupted by interference between the weight 16 and the sides of the housing 11.

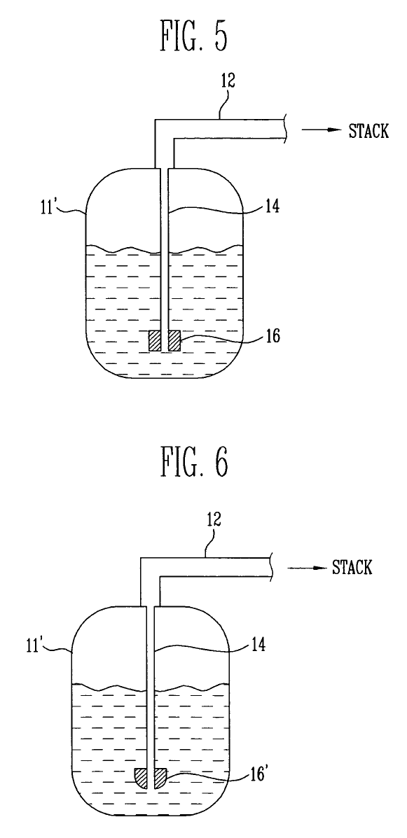

Referring to FIG. 5, the fuel feeder 10 may include a housing 11′ to store the fuel that may include an opening at one side thereof. As shown in FIG. 5, the housing 11′ may include a rounded shape, such as a circle, or an ellipse. The rounded shape of the housing 11′ may reduce interference between the weight 16 and the inner wall of the housing 11′ to continuously supply fuel to the stack. Alternatively, the housing may include a rounded shape and an angled shape.

Likewise, as shown in FIG. 6, the fuel feeder 10 may include a weight 16′ that includes a rounded shape, such as a circle or a semicircle. The rounded shape of the weight 16 may reduce interference between the inner wall of the elliptical housing 11′ and the weight 16 so that fuel is continuously supplied to the stack 20.

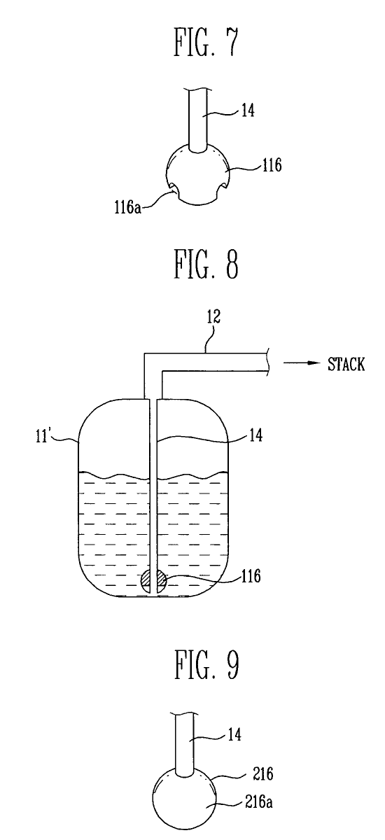

As shown in FIG. 7, the fuel feeder 10 may include a weight 116 formed with through holes 116a coupled with the free end of the flexible guiding pipe 14. The through holes 116a may allow fuel to be continuously supplied to the stack 20 even though the free end of the flexible guiding pipe 14 may be in contact with the bottom of the housing 11′.

The operation of a fuel cell system according to an exemplary embodiment of the present invention will now be described.

The fuel stored in the housing 11 may be continuously supplied to the stack 20 by the feeder via the through hole 116a of the weight 16, 16′ or 116 and/or the free end of the flexible guiding pipe 14, and the feeding pipe 12.

Fuel and air may be supplied to the anode and the cathode of the stack 20, respectively. Electricity may be generated by oxidizing hydrogen and then may be supplied to an external circuit.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A fuel tank, comprising:
a housing to store a fuel, the housing comprising an opening at one side;
a feeding pipe coupled with the opening;
a flexible pipe arranged within the housing and coupled with the feeding pipe; and
a weight coupled with a free end of the flexible pipe.

2. The fuel tank of claim 1, further comprising:
a float coupled to the flexible pipe and arranged between the free end of the flexible pipe and an end of the flexible pipe that is coupled with the feeding pipe.

3. The fuel tank of claim 1,
wherein the weight comprises a rounded shape.

4. The fuel tank of claim 3,
wherein the rounded shape comprises a circular shape or a semicircular shape.

5. The fuel tank of claim 2,
wherein the weight comprises a rounded shape.

6. The fuel tank of claim 5,
wherein the rounded shape comprises a circular shape or a semicircular shape.

7. The fuel tank of claim 1,
wherein the housing comprises a rounded shape.

8. The fuel tank of claim 7,
wherein the rounded shape comprises a circular shape or an elliptical shape.

9. The fuel tank of claim 7,
wherein the weight comprises a rounded shape.

10. The fuel tank of claim 2,
wherein the housing comprises a rounded shape.

11. The fuel tank of claim 10,
wherein the rounded shape comprises a circular shape or an elliptical shape.

12. The fuel tank of claim 10,
wherein the weight comprises a rounded shape.

13. The fuel tank of claim 1,
wherein the weight comprises a through hole that is coupled with the free end of the flexible pipe.

14. The fuel tank of claim 1,
wherein the weight comprises a plurality of pores.

15. The fuel tank of claim 14,
wherein the weight comprises porous metal or porous ceramic.

16. The fuel tank of claim 2,
wherein the weight comprises a plurality of pores.

17. The fuel tank of claim 7,
wherein the weight comprises a plurality of pores.

18. A fuel cell system, comprising
an electricity generator to generate electricity using an electrochemical reaction between hydrogen and oxygen; and
a fuel feeder to supply a hydrogen containing fuel to the electricity generator,
wherein the fuel feeder comprises a fuel tank comprising:
a housing to store a hydrogen containing fuel, the housing comprising an opening at one side;
a feeding pipe coupled with the opening;
a flexible pipe arranged within the housing and coupled with the feeding pipe; and
a weight coupled with a free end of the flexible pipe.

19. The fuel cell system of claim 18, further comprising:
a float coupled to the flexible pipe and arranged between the free end of the flexible pipe and an end of the flexible pipe that is coupled with the feeding pipe.

20. The fuel cell system of claim 18,
wherein the weight comprises a rounded shape.

21. The fuel cell system of claim 20,
wherein the rounded shape comprises a circular shape or a semicircular shape.

22. The fuel cell system of claim 19,
wherein the weight comprises a rounded shape.

23. The fuel cell system of claim 22,
wherein the rounded shape comprises a circular shape or a semicircular shape.

24. The fuel cell system of claim 18,
wherein the housing comprises a rounded shape.

25. The fuel cell system of claim 24,
wherein the rounded shape comprises a circular shape or an elliptical shape.

26. The fuel cell system of claim 24,
wherein the weight comprises a rounded shape.

27. The fuel cell system of claim 19,
wherein the housing comprises a rounded shape.

28. The fuel cell system of claim 27,
wherein the rounded shape comprises a circular shape or an elliptical shape.

29. The fuel cell system of claim 27,
wherein the weight comprises a rounded shape.

30. The fuel cell system of claim 18,
wherein the weight comprises a through hole that is coupled with the free end of the flexible pipe.

31. The fuel cell system of claim 18,
wherein the weight comprises a plurality of pores.

32. The fuel cell system of claim 31,
wherein the weight comprises porous metal or porous ceramic.

33. The fuel cell system of claim 19,
wherein the weight comprises a plurality of pores.

34. The fuel cell system of claim 24,
wherein the weight comprises a plurality of pores.
